(19) United States
(12) Patent Application Publication
(10) Pub. No.: US 2017/0046708 A1
(43) Pub. Date: Feb. 16, 2017

(54) DETECTING AND RESPONDING TO POTENTIALLY FRAUDULENT TENDER

(71) Applicant: Wal-Mart Stores, Inc., Bentonville, AR (US)

(72) Inventors: Donald High, Noel, MO (US); Michael Dean Atchley, Springdale, AR (US); Nick Rone, Bentonville, AR (US)

(21) Appl. No.: 15/226,540

(22) Filed: Aug. 2, 2016

Related U.S. Application Data
(60) Provisional application No. 62/203,344, filed on Aug. 10, 2015.

(51) Int. Cl. G06Q 20/40; G08B 13/196; G08B 21/18; G06Q 20/20

(52) U.S. Cl. CPC G06Q 20/4016; G06Q 20/20; G08B 13/196; G08B 21/18

(57) ABSTRACT

The present disclosure extends to methods, systems, and computer program products for detecting and responding to potentially fraudulent tender. A customer presents a form of a tender at a Point-of-Sale (POS) terminal in a retail location. The tender is presented as payment for one or more items. Transaction data, including tender data, item data, and geographic data, is sent to a central system for analysis. The central system determines that the presented tender is potentially fraudulent based on: the one or more items, purchase history associated with the presented tender, and the geographic location of the POS terminal. In response, in-store surveillance equipment at the retail location is used to save a recording of the customer. One or more parties designated for asset protection are alerted about the potentially fraudulent tender.

### CROSS-REFERENCE TO RELATED APPLICATIONS

This application claims the benefit of U.S. Provisional Patent Application 62/203,344, filed Aug. 10, 2015, and titled “Detecting And Responding To Potentially Fraudulent Tender”, the entire contents of which are hereby incorporated herein by reference.

### BACKGROUND

1. Field of the Invention

This invention relates generally to fraud detection in retail settings and more specifically to detecting and responding to detection of potentially fraudulent tender.

2. Related Art

In a retail environment, there is a variety of different types of payment (or “tender”) that can be used to cover a debt incurred for purchasing items from a retail store. The different types of tender include: paper currency, coins, credit cards, gift cards, and checks. Many of the different types of tender are subject to fraudulent use. Fraudulent use of tender to purchase items from a retail store harms the retail store, other customers and, if the tender has been misappropriated (e.g., stolen), can also harm the rightful owner of the tender.

Depending on the type of tender, detecting fraudulent tender and/or fraudulent use of tender can be relatively complex. For example, if a gift card is loaded in Alaska and then used in Florida moments later, there is some likelihood of fraud. Even if tender is potentially fraudulent, there may be little a retail store can do when tender (e.g., a gift card) is outside the realm of the credit card companies. For example, if a credit card transaction is somewhat suspicious, but the credit card has not been reported stolen, the retail store may accept the credit card for payment. Even if the retail store refuses to accept the credit card as payment, the retail store may determine that the person presenting the credit card cannot be legally detained. Since the customer is not detained, the retail store may not document the incident or may document the incident in a summarily manner leaving out various details.

The same person may go to another retail store and use the credit card again (later the same day, the next day, etc.). The other retail store is then put in the same position to accept or refuse the credit card as acceptable tender. The additional use of the credit card can provide further evidence of fraud. However, the other retail store may not be aware of prior use of the credit card at the retail store. As such, the other retail store (lacking knowledge the credit card's prior use) may also determine that the person presenting the credit card cannot be legally detained. Again, since the customer is not detained, the retail store may not document the incident or may document the incident in a summarily manner leaving out various details.

As such, limited information exchange and insufficiently detailed documentation makes it more difficult to identify and detain individuals using fraudulent tender. Thus, even when an overall pattern of fraudulent use of tender is present, multiple retail locations (even if owned by the same entity) may not be aware of the incidents at other retail locations. At least in part as a result, it may take longer to catch individuals using fraudulent tender or individuals using fraudulent tender may not be caught.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates detecting and responding to potentially fraudulent tender.

FIG. 3 illustrates an example method for detecting and responding to potentially fraudulent tender.

FIG. 4 illustrates an example component model that facilitates detecting and responding to detection of potentially fraudulent tender.

FIG. 5 illustrates an example process flow for detecting and responding to potentially fraudulent tender.

### DETAILED DESCRIPTION

The present invention extends to systems, methods, and computer program products for detecting and responding to potentially fraudulent tender. In some aspects, a customer presents a form of a tender at a Point-of-Sale (POS) terminal in a retail location. The tender is presented as payment for one or more items the customer is purchasing from the retail location. Transaction data, including tender data, item data, and geographic data, is sent to a central system for analysis. An analysis module at the central system receives the transaction data.

The analysis module determines that the presented tender is potentially fraudulent based on: the one or more items, purchase history associated with the presented tender, and the geographic location of the POS terminal. In response, in-store surveillance equipment at the retail location is used to save a recording of the customer. The transaction data and the recording of the customer are retained for use in tracking subsequent use of the potentially fraudulent tender and in determining if the potentially fraudulent tender is actually fraudulent. One or more parties designated for asset protection are alerted about the potentially fraudulent tender.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, wearable devices, multi-processor systems, microprocessor-based or programmable consumer electronics, network PCs, minicomputers, mainframe computers, mobile telephones, watchers, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”)), and deployment models (e.g., private cloud, community cloud, public cloud, hybrid cloud, etc.).

It is further noted that, where feasible, functions described herein can be performed in one or more of: hardware, software, firmware, digital components, or analog components. For example, one or more application specific integrated circuits (“ASICs”) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

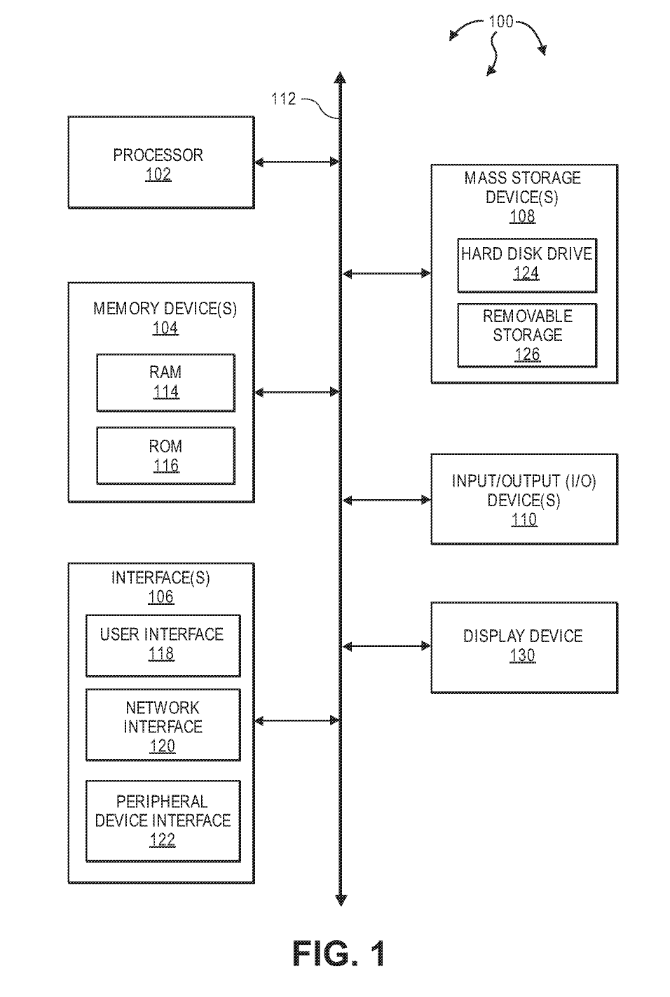

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (“RAM”) 114) and/or nonvolatile memory (e.g., read-only memory (“ROM”) 116). Memory device(s) 104 may also include rewritable ROM, such as Flash memory.

Mass storage device(s) 108 include various hardware storage devices, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 can include any number of different network interfaces 120, such as interfaces to personal area networks (“PANs”), local area networks (“LANs”), wide area networks (“WANs”), wireless networks (e.g., near field communication (“NFC”), Bluetooth, Wi-Fi, etc. networks), and the Internet. Other interfaces include user interface 118 and peripheral device interface 122.

Bus 112 allows processor(s) 102, memory device(s) 104, interface(s) 106, mass storage device(s) 108, and I/0 device(s) 110 to communicate with one another, as well as other devices or components coupled to bus 112. Bus 112 represents one or more of several types of bus structures, such as a system bus, PCI bus, IEEE 1394 bus, USB bus, and so forth.

In general, aspects of the invention are directed to detecting and responding to detection of fraudulent or potentially fraudulent tender. In-store fraud alert and video detects when a customer uses fraudulent or potentially fraudulent tender to purchase items at a Point-Of-Sale (POS) terminal. Asset protection can be alerted when a customer uses fraudulent or potentially fraudulent tender. Asset protect can be alerted by sending a message and focusing surveillance equipment (e.g., one or more video cameras) on the POS terminal and/or the customer. In response to the alert and/or video evidence, asset protection can record the event, notify law enforcement, reject the payment, allow the payment, take action at a later time, etc.

Advantageously, aspects of the invention include automatic determination of fraudulent or potentially fraudulent activity at a POS terminal. Asset protection can be automatically notified of fraudulent or potentially fraudulent tender. Surveillance equipment can be refocused for identification at a POS terminal where fraudulent or potentially fraudulent tender is presented.

In one aspect, transaction data and surveillance data from multiple retail locations (having the same or different owners) is aggregated at a central system. When a customer presents tender at a POS terminal to complete a transaction, the POS terminal can forward transaction data, including an indication of the presented tender, to the central system. The central system can analyze the transaction data, in combination with portions of the aggregated data relevant to the customer and/or the presented tender, to determine if the tender is fraudulent or potentially fraudulent. As such, a chain or group of retail locations can use essentially real-time, chain or group wide analytics to identify customers using fraudulent or potentially fraudulent tender. Fraudulent or potentially fraudulent use of tender can be detected from a usage anomaly.

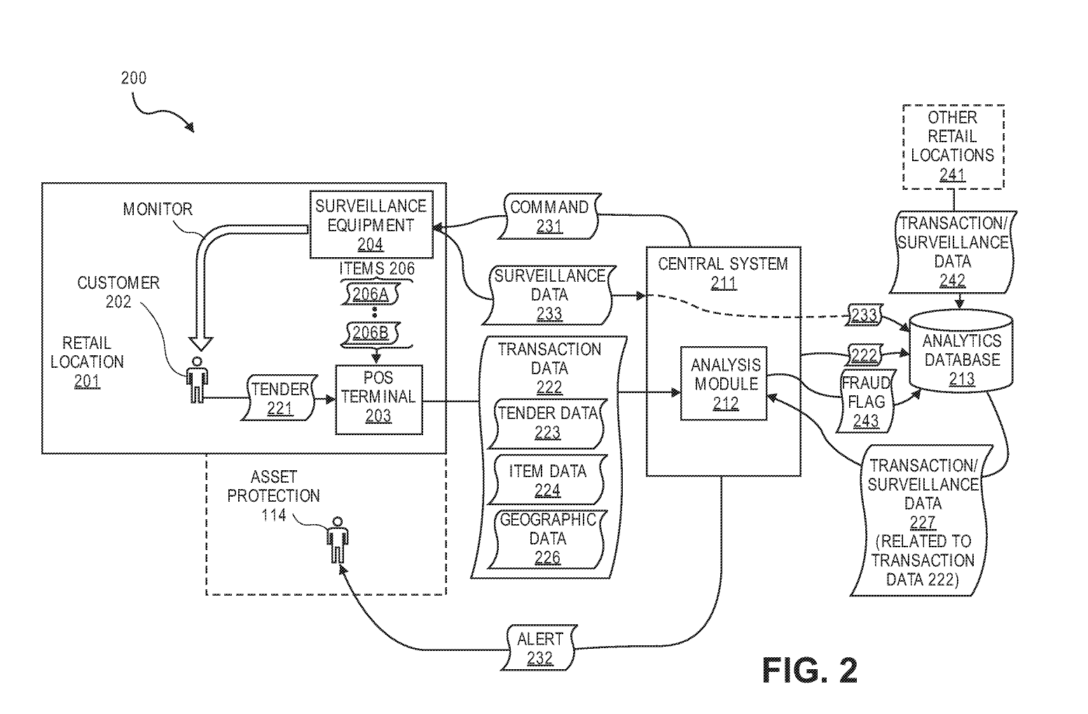

FIG. 2 illustrates an example computer architecture 200 that facilitates detecting and responding to potentially fraudulent tender. As depicted, computer architecture 200 includes POS terminal 203, surveillance equipment 204, central system 211, and analytics database 213. POS terminal 203, surveillance equipment 204, central system 211, and analytics database 213 can be connected to a network. The network can comprise a local area network (LAN), a wide area network (WAN), or any other type of communication network. In one exemplary embodiment, the network comprises the Internet, and messages are communicated across the network using transmission control protocol/Internet protocol (TCP/IP). However, other types of networks and other types of protocols can be used.

As transactions occur, retail location 201 as well as other retail locations 241 can send transaction data and surveillance data for storage in analytics database 213. For example, other retail locations 241 can send transaction/surveillance data 242 to analytics database 213. As such, analytics database 213 can store chain wide or group wide data related to tender usage and surveillance of tender usage at a plurality of retail locations.

At retail location 201, customers (with possible assistance form a cashier) can use POS terminal 203 (or possibly other POS terminals) to complete transactions for the purchase of items from retail location 201. POS terminals at retail location 201 (including POS terminal 203) can be connected to a backend accounting and inventory system, to card authorization networks, to central system 211, and to any other appropriate systems related to the operation of retail location 201 or the owner of retail location 201.

As depicted, central system 211 includes analysis module 212. During a transaction, a POS terminal (at retail location 201 and/or at other retail locations 241) can send transaction data to central system 211. Transaction data can include tender data identifying presented tender, item data identifying items being purchased, time and data of user, and geographical data of the retail location. On a per transaction basis, analysis module 212 can analyze corresponding transaction data to attempt to identify fraudulent or potentially fraudulent tender. Analysis module 212 can use a variety of methods to identify fraudulent tender and/or potentially fraudulent tender based on items purchased, purchase history (by reference to other data in analytics database 213), in-store behavior (currently observed and/or previously recorded) and in accordance with established thresholds defining fraudulent use of tender.

When analysis module 212 identifies tender as fraudulent or potentially fraudulent, central system 211 can alert asset protection at the relevant store location and/or can direct surveillance equipment at the relevant store location to monitor the remainder of a transaction. Asset protection can respond to fraudulent tender or potentially fraudulent tender in a designated manner.

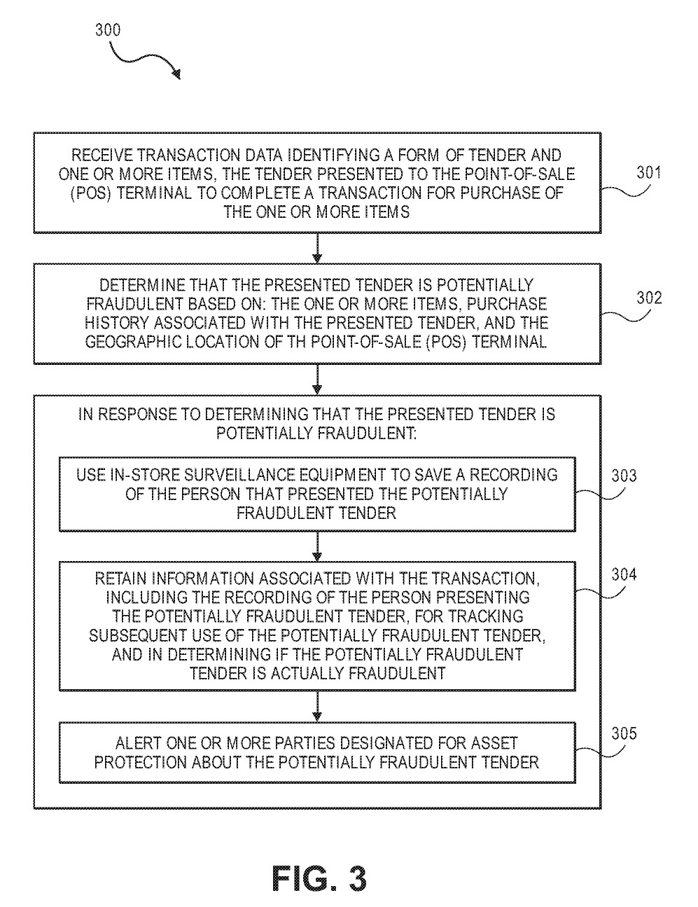

FIG. 3 illustrates a flow chart 300 of an exemplary method 300 for detecting and responding to potentially fraudulent tender. The method 300 will be described with respect to the data and modules in computer architecture 200.

During operation of retail location 201, customer 202 can present tender 221 at POS terminal 203 as payment for items 206 (106A, 206B, etc.). In response, POS terminal 203 can send transaction data 222 to central system 211. As depicted, transaction data 222 includes tender data 223 (identifying tender 221), item data 224 (identifying each of items 206A, 206B, etc.), and geographic data 226 (indicating the geographic location of retail location 201).

Method 300 includes receiving transaction data identifying a form of tender and one or more items, the tender presented to the Point-of-Sale (POS) terminal to complete a transaction for purchase of the one or more items (301). For example, central system 211 can receive transaction data 222 from POS terminal 203.

Method 300 includes determining that the presented tender is potentially fraudulent based on: the one or more items, purchase history associated with the presented tender, and the geographic location of the Point-of-Sale (POS) terminal (302). For example, analysis module 212 can determine that tender 221 is fraudulent or potentially fraudulent. Analysis module 212 can access transaction/surveillance data 227 from analytics database 212. Transaction/surveillance data 227 can relate to prior uses of tender 221 and/or behavior of customer 202 during prior transactions (which may or may not have included tender 221). In one aspect, transaction/surveillance data 227 includes purchase history associated with tender 221, including previously purchased items, geographic locations of use, times and dates of use, etc. As such, analysis module 212 can determine that tender 221 is fraudulent or potentially fraudulent based on identification of items 206A, 206B, etc., a purchase history corresponding to tender 221, and the geographic location of retail location 201. For example, if a gift card is being used in New York and was last used in Anchorage less than two hours ago, analysis module 212 can determine that the gift card is potentially fraudulent (or that the prior use of the gift card was potentially fraudulent).

In response to determining that tender 221 is fraudulent or potentially fraudulent, analysis module 212 can flag tender 221 with fraud flag 243 in analytics database 213.

In response to determining that the presented tender is potentially fraudulent, method 300 includes using in-store surveillance equipment to save a recording of the person that presented the potentially fraudulent tender (303). For example, central system 211 can send command 231 (e.g., a network command) to surveillance equipment 204 (including one or more cameras inside retail location 201). Command 231 electronically directs surveillance equipment 204 to automatically monitor customer 202 and/or POS terminal 203 for the remainder of the transaction. Surveillance equipment 204 can be used to record (both audio and video of) customer 202 during the remainder of the transaction.

In response to determining that the presented tender is potentially fraudulent, method 300 includes retaining information associated with the transaction, including the recording of the person presenting the potentially fraudulent tender, for tracking subsequent use of the potentially fraudulent tender, and in determining if the potentially fraudulent tender is actually fraudulent (304). For example, surveillance equipment 204 can return surveillance data 233 (e.g., an audio/video recording) to central system 211. Central system 211 can store surveillance data 233 in analytics database 233. Central system 211 can also store transaction data 222 in analytics database 233. Analysis module 212 can also flag tender 221 with fraud flag 243 in analytics database 213. Transaction data 222, surveillance data 233, and fraud flag 243 can be used to track subsequent use of tender 221 and determine if tender 221 is actually fraudulent.

In response to determining that the presented tender is potentially fraudulent, method 300 includes alerting one or more parties designated for asset protection about the potentially fraudulent tender (305). For example, central system 211 can send alert 232 to assent protection personnel 214. Asset protection personnel 214 can be a store manager, store security, loss prevention, etc. Asset protection 214 can take one or more actions in response to alert 232, including but not limited to: contacting other store personnel, contacting law enforcement, triggering an alarm, denying the transaction, sending a message to the true owner of tender 221, detaining customer 202, request a second form of identification from customer 202, etc.

In one aspect, asset protection is set up according to action classifications. The action classifications define actions a retail store is take when fraudulent or potentially fraudulent tender is used. Action classifications include: (a) who should be contacted (CSM, Store Manager, Security, Law enforcement), (b) how contacted (pager, phone, email, text, etc.), (c) type of alarm (silent, red-light, sirens, etc.), (d) level of urgency, (e) level of caution or danger, (I) message to be delivered to customer, (g) whether to accept purchase, (h) whether to detain customer, (i) request a second form of ID, etc.

In another aspect, tender is flagged as fraudulent in an analytics database based on the true owner of the tender reporting the tender as missing or stolen. Thus, an subsequent use of the tender can be identified as a fraudulent use and appropriate actions taken

Another example of fraud or abuse includes items bought in volume or in certain combination that are illegal, or might require legal intervention. For example, items used to produce methamphetamine are restricted to certain volumes. Once a limit is reached, information can be captured, or sent to proper authorities. A central system can combine all transactions from the same individual, across a chain or group of retail locations and over time, to assist in the apprehension of a customer that is potentially breaking the law.

In a further aspect, a central system intermittently receives lost and stolen card data from credit card companies. The central system stores the lost and stolen card data in an analytics database. When any lost or stolen card is presented as tender, the individual presenting the tender can be detained or law enforcement alerted.

Customers can chose to opt in for notifications so that they can be notified (e.g., through a mobile application) when their cards are used.

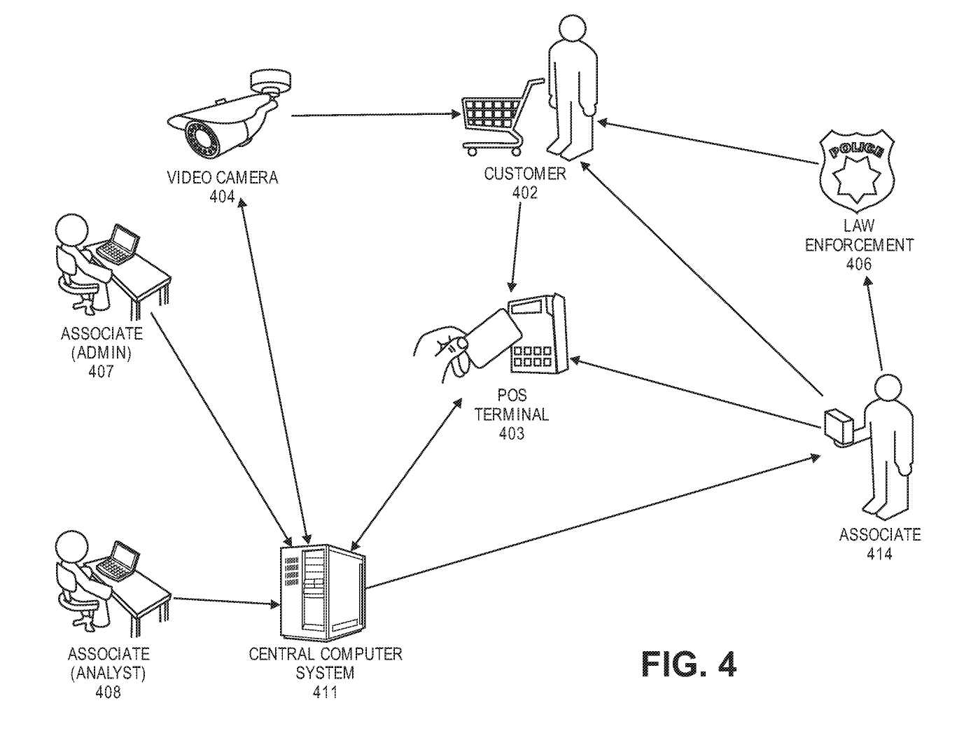

FIG. 4 illustrates an example component model 400 that facilitates detecting and responding to potentially fraudulent tender. As depicted, component model 400 includes customer 402, POS terminal 403, video camera 404, law enforcement 406, associate 407 (an admin), associate 408 (an analyst), central computer system 411, and associate 414 (asset protection). Some or all of the components in component model 400 can be connected to one another (either directly or by utilized electronic devices) through a network. The network can comprise a local area network (LAN), a wide area network (WAN), or any other type of communication network. In one exemplary embodiment, the network comprises the Internet, and messages are communicated across the network using transmission control protocol/Internet protocol (TCP/IP). However, other types of networks and other types of protocols can be used.

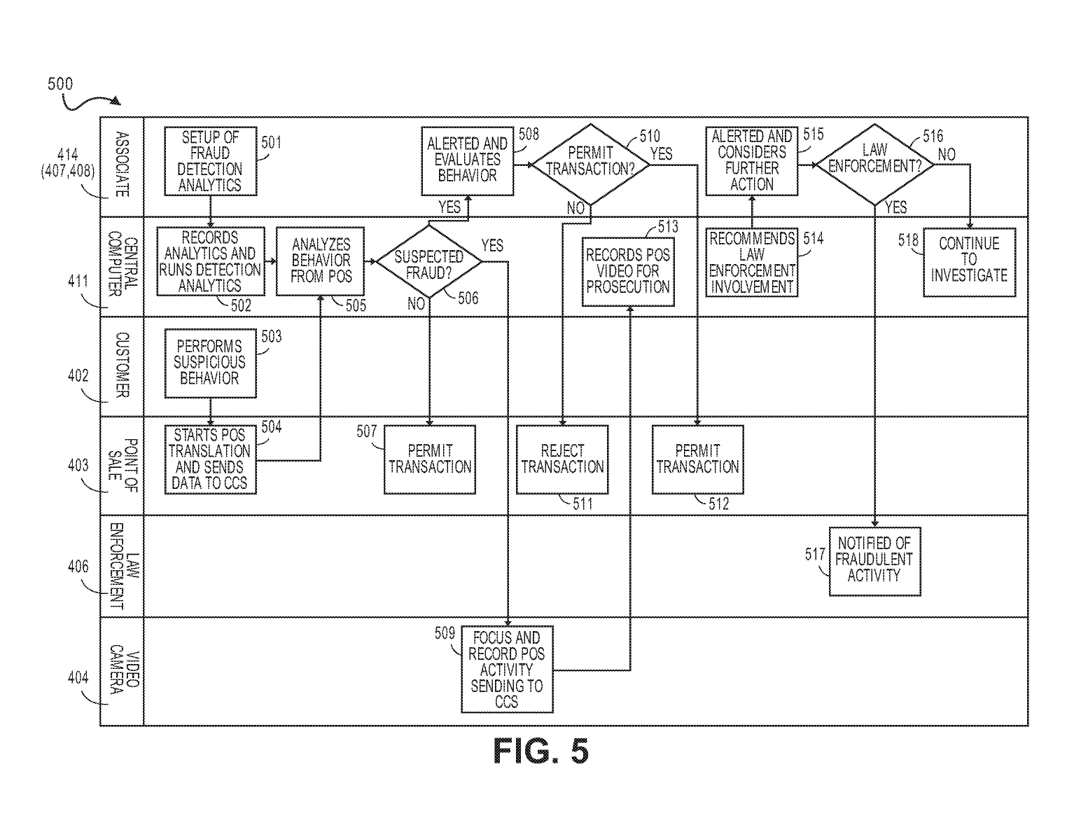

FIG. 5 illustrates an example process flow 500 for detecting and responding to potentially fraudulent tender. The process flow 500 will be described with respect to the data and modules in computer architecture 400.

Process flow 500 includes associate 407 (e.g., an administrator) setting up fraud detection analytics (501). Setting up fraud detection analytics can include mapping video cameras to POS terminal locations and setting up thresholds defining fraudulent used of tender. For example, associate 407 can map video camera 404 to POS terminal 403. After set up, central computer system 411 records analytics and runs detection analytics (502). Customer 402 performs suspicious behavior (503). POS terminal 403 starts a Point-Of-Sale Transaction and sends transaction data to central computer system 411 (504). Central computer system 411 analyzes behavior from POS terminal 403 (505).

Central computer system 411 determines if fraud is suspected (decision 506). Fraud can be suspected when thresholds defining fraudulent use of tender are satisfied. If fraud is not suspected (NO at decision 506), the transaction is permitted (507). If fraud is suspected (YES at decision 506), associate 414 is alerted and evaluates the behavior of customer 402 (508) and video camera 404 is focused on customer 402 to record POS activity and sends to central computer system 411 (509). Central computer system 411 stores record POS activity for use in criminal prosecution (513).

From his or her evaluation of customer 402, associate 414 determines if the transaction is to be permitted (decision 510). If the transaction is not to be permitted (NO at decision 501), the transaction is rejected (511). If the transaction is to be permitted (YES at decision 501), the transaction is permitted (512).

Central computer system 411 can also automatically recommend law enforcement involvement to associate 408 and/or associate 414 (514). Associate 408 and/or associate 414 can be alerted and consider further action (515). For example, associate 408 can extract and analyze further data from central computer system 411. Associate 414 can further evaluate the behavior of customer 402. Associate 408 and/or associate 414 can determine if law enforcement involvement is appropriate (decision 516). If law enforcement involvement is appropriate (YES at decision 516), associate 408 and/or associate 414 can notify law enforcement 406 of fraudulent (or other criminal) activity (517). If law enforcement involvement is not appropriate (No at decision 516), associate 408 and/or associate 414 can continue to investigate (518). For example, associate 408 can continue to extract and analyze further data related to customer 402 and/or presented tender from central computer system 411. Associate 414 may choose to question customer 402 or request a second form of identification form customer 402. When appropriate, associate 408 and/or associate 414 can override thresholds defining fraudulent use of tender.

In one aspect, a transaction is permitted to complete even though the presented tender is known to be fraudulent tender. For example, an analyst or asset protection personnel may permit a transaction with fraudulent tender so that the fraudulent activity can be fully documented for later use as evidence.

In another aspect, multiple transactions are permitted to complete even though presented tender is known to be fraudulent tender. A central computer system can track the ongoing use of fraudulent tender, possibly even after potential criminal activity is initially detected. Tracking can be used to build a stronger case against an individual or group of individuals using fraudulent tender or engaging in other criminal activity.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for use at a computer system, the computer system including one or more processors and system memory, a method for responding to potentially fraudulent use of tender at the Point-of-Sale (POS) terminal, the method comprising:
receiving transaction data identifying a form of tender and one or more items, the tender presented to the Point-of-Sale (POS) terminal to complete a transaction for purchase of the one or more items;
determining that the presented tender is potentially fraudulent based on: the one or more items, purchase history associated with the presented tender, and the geographic location of the Point-of-Sale (POS) terminal;
in response to determining that the presented tender is potentially fraudulent:
using in-store surveillance equipment to save a recording of the person that presented the potentially fraudulent tender;
retaining information associated with the transaction, including the recording of the person presenting the potentially fraudulent tender, for tracking subsequent use of the potentially fraudulent tender, and in determining if the potentially fraudulent tender is actually fraudulent; and
alerting one or more parties designated for asset protection about the potentially fraudulent tender.

2. The method of claim 1, wherein the computer system is a central computer system that aggregates transaction data form a plurality of retail locations, including the retail location of the Point-of-Sale (POS) terminal.

3. The method of claim 1, wherein the computer system is a central computer system designated to track information about potentially fraudulent uses of tender for processing at Point-of-Sale (POS) terminals.

4. The method of claim 1, further comprising, in response to determining that the presented tender is potentially fraudulent, activating an alarm.

5. The method of claim 1, further comprising, in response to determining that the presented tender is potentially fraudulent, denying the presented tender as a valid form of payment for the one or more items.

6. The method of claim 1, further comprising, in response to determining that the presented tender is potentially fraudulent, determining whether the person that presented the potentially fraudulent tender is to be detained.

7. The method of claim 1, further comprising, in response to determining that the presented tender is potentially fraudulent, determining that an additional form of identification is to be requested from the person that presented the potentially fraudulent tender.

8. The method of claim 1, wherein using in-store surveillance equipment to save a recording of the person that presented the potentially fraudulent tender comprises sending a network command to a video camera to electronically direct the video camera to focus on an area around the Point-of-Sale (POS) terminal to capture video imagery of the person attempting to use the potentially fraudulent tender.

9. The method of claim 1, wherein alerting one or more parties designated for asset protection comprises alerting one or more of: a store manager, store security, and law enforcement authorities.

10. The method of claim 1, wherein determining that the presented tender is potentially fraudulent comprises, prior to the tender being presented for purchase of the one or more items, receiving a notification from an owner of the presented tender that the presented tender is missing or that the presented tender has been stolen.

11. The method of claim 10, further comprising, in response to determining that the presented tender is potentially fraudulent, notifying the owner that the presented tender was presented to purchase the one or more items.

12. The method of claim 1, wherein determining that the presented tender is potentially fraudulent comprises, prior to the tender being presented for purchase of the one or more items, receiving a notification from a credit card company that the presented tender has been reported as missing or stolen.

13. The method of claim 1, wherein determining that the presented tender is potentially fraudulent comprises:
analyzing one or more sets of transaction data, the one or more sets of transaction data including: purchase history associated with the potentially fraudulent tender, in-store behavior of the person that presented the potentially fraudulent tender, and thresholds defining fraudulent use of tender; and
determining that the transaction satisfies the thresholds defining fraudulent use of tender.

14. A computer program product for use at a computer system, the computer program product for implementing a method for responding to potentially fraudulent use of tender at the Point-of-Sale (POS) terminal, the computer program product comprising one or more computer storage devices having stored thereon computer-executable instructions that, when executed at a processor, cause the computer system to perform the method, including the following:
receive transaction data identifying a form of tender and one or more items, the tender presented to the Point-of-Sale (POS) terminal to complete a transaction for purchase of the one or more items;
determine that the presented tender is potentially fraudulent based on: the one or more items, purchase history associated with the presented tender, and the geographic location of the Point-of-Sale (POS) terminal;
in response to determining that the presented tender is potentially fraudulent:
use in-store surveillance equipment to save a recording of the person that presented the potentially fraudulent tender;
retain information associated with the transaction, including the recording of the person presenting the potentially fraudulent tender, for tracking subsequent use of the potentially fraudulent tender, and in determining if the potentially fraudulent tender is actually fraudulent; and
alert one or more parties designated for asset protection about the potentially fraudulent tender.

15. The computer program product of claim 14, wherein the computer system is a central computer system that aggregates transaction data form a plurality of retail locations, including the retail location of the Point-of-Sale (POS) terminal.

16. The computer program product of claim 14, wherein the computer system is a central computer system designated to track information about potentially fraudulent uses of tender for processing at Point-of-Sale (POS) terminals.

17. The computer program product of claim 14, wherein computer-executable instructions that, when executed, cause the computer system to use in-store surveillance equipment to save a recording of the person that presented the potentially fraudulent tender comprise computer-executable instructions that, when executed, cause the computer system to send a network command to a video camera to electronically direct the video camera to focus on an area around the Point-of-Sale (POS) terminal to capture video imagery of the person attempting to use the potentially fraudulent tender.

18. The computer program product of claim 14, wherein computer-executable instructions that, when executed, cause the computer system to determine that the presented tender is potentially fraudulent comprise computer-executable instructions that, when executed, cause the computer system to:
analyze one or more sets of transaction data, the one or more sets of transaction data including: purchase history associated with the potentially fraudulent tender, in-store behavior of the person that presented the potentially fraudulent tender, and thresholds defining fraudulent use of tender; and
determine that the transaction satisfies the thresholds defining fraudulent use of tender.

19. The computer program product of claim 14, further comprising computer-executable instructions that, when executed, cause the computer system to receive an override of the thresholds permitting transaction to complete, the override allowing use of the fraudulent tender to be more fully documented.

20. A computer system, the computer system comprising:
system memory;
one or more processors; and
one or more computer storage devices having stored thereon computer-executable instructions representing an analysis module, the analysis module configured to:
receive transaction data through network communication, the transaction data identifying a form of tender and one or more items, the tender presented to the Point-of-Sale (POS) terminal to complete a transaction for purchase of the one or more items;
determine that the presented tender is potentially fraudulent based on: the one or more items, purchase history associated with the presented tender, and the geographic location of the Point-of-Sale (POS) terminal;
in response to determining that the presented tender is potentially fraudulent:
send a network command to in-store surveillance equipment at the geographic location to instruct the in-store surveillance equipment to save a recording of the person that presented the potentially fraudulent tender by t;
retain information associated with the transaction, including the recording of the person presenting the potentially fraudulent tender, for tracking subsequent use of the potentially fraudulent tender, and in determining if the potentially fraudulent tender is actually fraudulent; and
electronically alert one or more parties designated for asset protection about the potentially fraudulent tender.
